(19) United States
(12) Patent Application Publication
(10) Pub. No.: US 2010/0186720 A1
(43) Pub. Date: Jul. 29, 2010

(54) LOW-ENERGY VALVE SYSTEM FOR A PRESSURIZED GAS ENGINE

(76) Inventor: Dominique Rochier, Biganos (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/676,573

(22) PCT Filed: Sep. 5, 2008
(86) PCT No.: PCT/EP2008/061808

§ 371 Date: Mar. 4, 2010

(30) Foreign Application Priority Data
Sep. 6, 2007 (FR) 0757397

(51) Int. Cl. F02B 75/04; F01B 31/00

(52) U.S. Cl. 123/48 AA; 92/181 P

(57) ABSTRACT

The system intended for a pressurized gas engine includes a variable-volume chamber and a valve (1) comprising a first fixed element (3) intended to allow fastening of the valve to the engine, a second moveable element (5) intended to shut off in a conditional manner a passage providing gas communication with the variable-volume chamber, and first elastically deformable coupling means (9) connecting the first and second elements together, the chamber additionally comprising means for operating the second and third moveable elements of the valve.

The invention relates to a system including an intake or exhaust valve for a pressurized gas engine.

By definition, a pressurized gas engine is an expansion engine where maximum pressure prevails substantially continuously in an intake or feed pipe of the engine. A particular embodiment of such a pressurized gas engine is a hot gas engine of the Ericsson type.

Document US 2005/0257523 describes a hot gas engine of the Ericsson type including an intake valve and an exhaust valve both comprising a flat head of circular shape mounted on the end of a rod with a substantially cylindrical shape. The opening and closing of the exhaust as well as of the intake by these valves is performed by using a camshaft, associated with each of the valves, which will press on the end opposite to the flat head of the cylindrical rod of each of the valves. The setting of these camshafts into motion is performed by the movement of rotation of the crankshaft of the Ericsson engine. This requires mechanical couplings between the camshaft and the crankshaft. The drawback of such a system is that a very great portion of the energy provided by the Ericsson motor is required for alternately opening and closing the intake and exhaust valves. This consumed energy drastically lowers the yield of such an engine.

One of the objects of the invention is to provide an improved system comprising an improved valve either intended for the intake or for the exhaust, for a pressurized gas engine which is not a very great consumer of energy during its use while allowing optimum circulation of the pressurized gas bringing the engine into play.

For this purpose, provision is made according to the invention for a system intended for a pressurized gas engine including:
a variable-volume chamber; and,
a valve comprising a first fixed element intended to allow fastening of the valve to the engine, a second movable element intended to shut off in a conditional manner a passage providing gas communication with the variable-volume chamber, and first elastically deformable coupling means connecting the first and second elements together,

the chamber further including means for operating the second movable element of the valve.

Advantageously, but optionally, the valve comprises one of the following characteristics the valve is a one-piece valve;
the valve forms a substantially flat leaf before deformation;
the valve is substantially of a circular shape;
the first and second elements have the shape of concentric rings;
at rest, the first and second elements are substantially in a same plane;
at rest, the first and second elements are in two different planes substantially parallel to each other;
the valve includes a third movable element capable of shutting off a second passage providing gas communication with the variable-volume chamber and second elastically deformable coupling means connecting the second and third elements to each other;
the third element has the shape of a substantially planar disk,
and/or second elastically deformable coupling means include tabs;
the tabs are of a substantially spiral shape and uniformly distributed over a circumference of the valve;
the operating means are intended to operate the third movable element of the valve;
the operating means include an elastically deformable element mounted on a piston delimiting the variable-volume chamber;
the elastic deformable element is of the compression spring type.

Provision is also made, according to the invention, for a pressurized gas engine including at least one valve having at least one of the preceding characteristics.

Other characteristics and advantages of the invention will become apparent during the description hereafter of an embodiment of an intake valve and then of an exhaust valve, as well as of an alternative embodiment. In the appended drawings:

FIG. 1 is a three-dimensional view of an intake valve according to an embodiment of the invention;

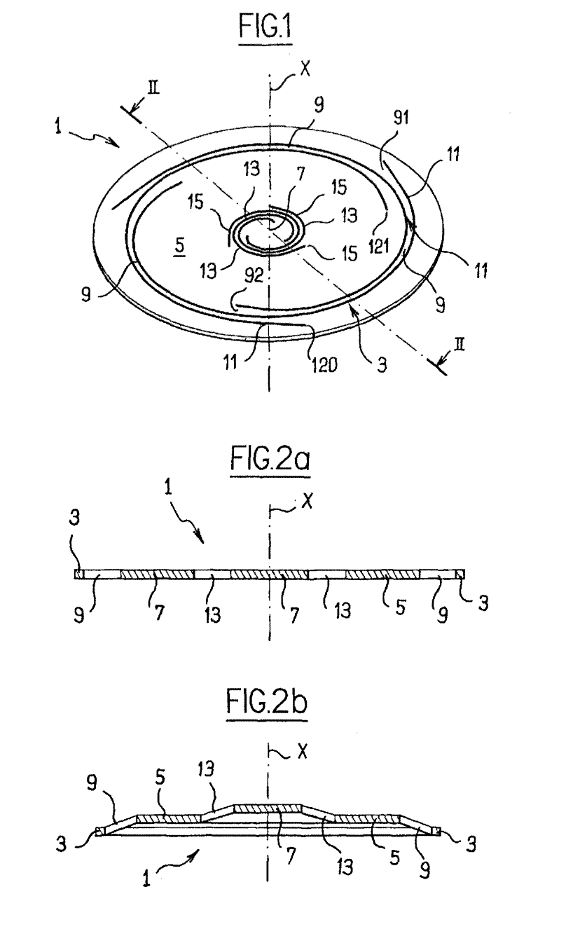

FIG. 2a is a sectional view along II-II of the valve of FIG. 1 at rest;

FIG. 2b is a sectional view along II-II of the valve of FIG. 1 in the open position;

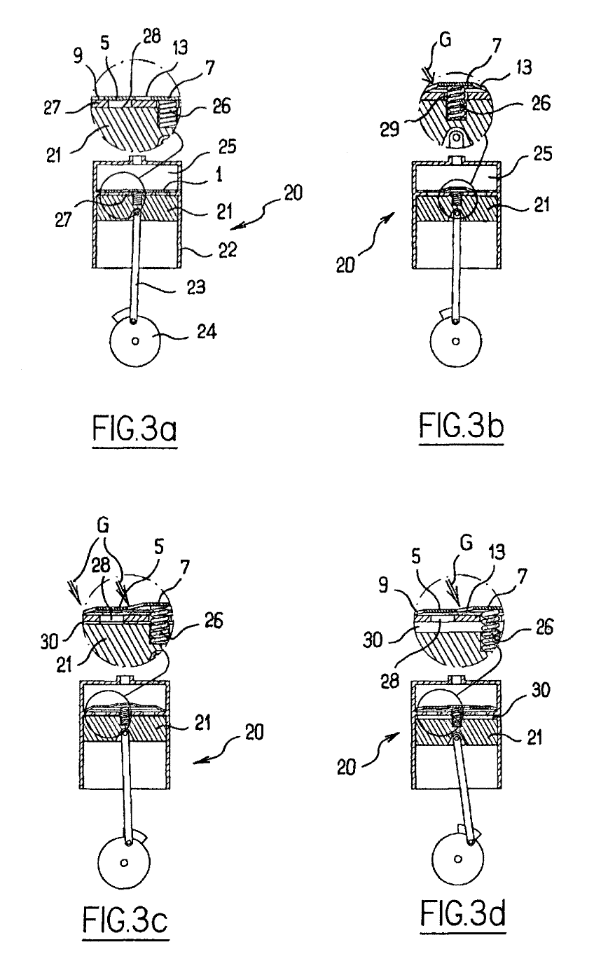

FIGS. 3a-3d are simplified schematic sectional views of a pressurized gas engine illustrating the steps for admitting a hot pressurized gas into the variable-volume chamber according to the invention;

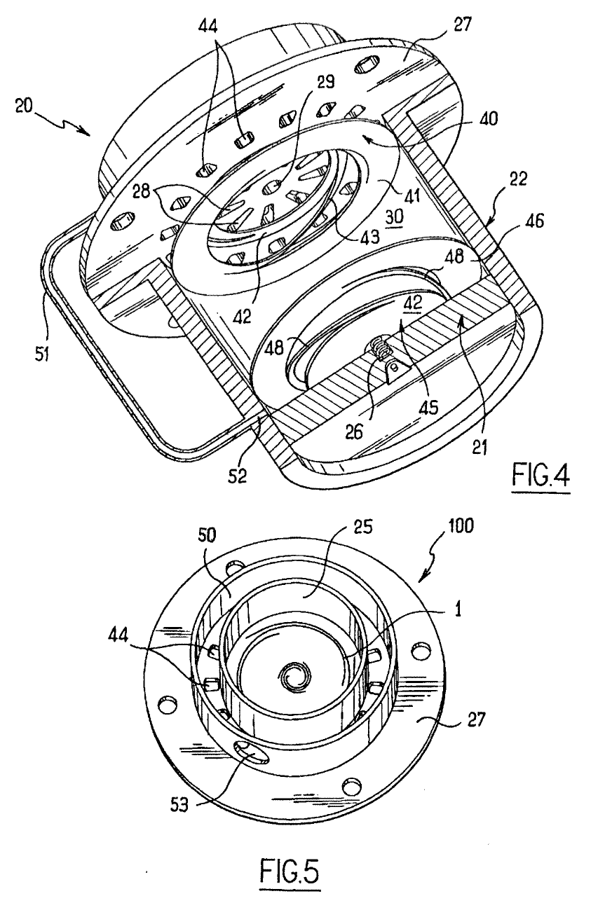

FIG. 4 is a three-dimensional half-sectional view of a cylinder of a pressurized gas engine illustrating an exhaust valve according to the invention;

FIG. 5 is a top three-dimensional view of the cylinder of FIG. 4;

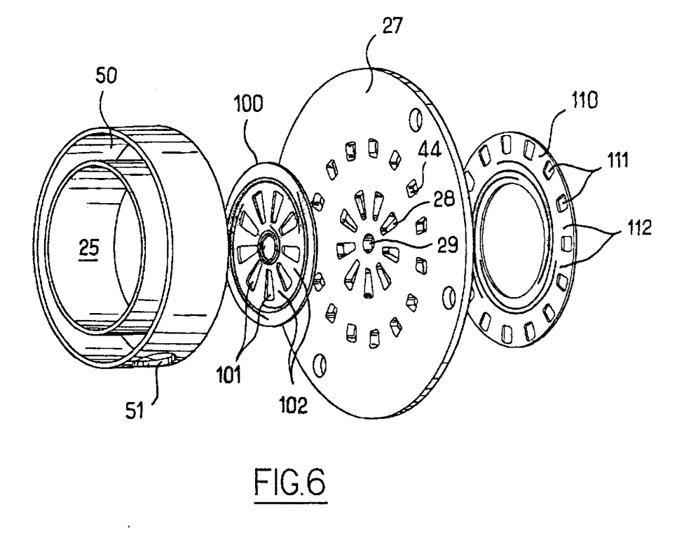

FIG. 6 is an exploded partial three-dimensional view illustrating an alternative embodiment of the intake valve and of the exhaust valve, both according to the invention.

With reference to FIGS. 1-2b, we shall describe an intake valve (1) according to the invention. The valve (1) appears here in the form of a leaf with small thickness and with an axisymmetrical shape around an axis (X). For example the thickness of the leaf is less than or equal to about 1 mm, advantageously less than or equal to 3/10^{th} of a mm.

It includes starting from an outer periphery towards the centre, a first substantially ring-shaped element (3), and then a series of tabs (9), and then a second ring-shaped element (5), and then a second series of tabs (13) and finally a third central substantially disk-shaped element (7).

The whole of the elements forming the valve (1) is made from the same material thereof, so that the valve is a one-piece valve. Alternatively, the valve consists of several different materials.

The first element (3) is said to be fixed since it allows fastening of the valve (1) on the pressurized gas engine onto which it is intended to be mounted. The second element (5) is said to be movable and is connected to the first element through the first series of tabs (9). The tabs (9) are substantially spiral-shaped and are wound about the axis (X) of the valve (1). Here, the tabs (9) are uniformly distributed over an outer circumference of the second movable element (5) and over an inner circumference of the first fixed element (3), the tabs (9) are made with the same materials as those of the movable element (5) and of the fixed element (3). They are also made by cutting out the leaf forming the valve (1). The thereby made cut-outs (11) themselves have a spiral shape, which are wound about the axis (X) of the valve (1). Each of the spiral cut-outs (11) in the clockwise direction has a first external end (120) which is located at an internal circumference of the first fixed element (3), followed by a winding around and towards the axis (X) of the valve (1) so as to end with a second end (121), which is substantially located on an external circumference of the second movable element (5). Thus, each cut-out (11) delimits, approximately in a first half, an external edge of a first tab (9) and then, approximately in a second half, an internal edge of a second tab (9) successive to the first tab (9). Finally, at the ends (120) and (121) of each of the spiral cut-outs (11), a flared portion (91) and (92) is laid out forming the ends of the tabs (9). With this flaring, the stresses which are likely to appear during deformation of these tabs may be better distributed, a deformation occurring during the opening of the intake valve (1) as this will be described later on.

In a quite similar way, the third element (7), which itself is also movable, is connected to the second movable element (5) through the second series of tabs (13) which are made in the same material of both the third movable element (7) and the second movable element (5). Also here, the series of tabs (13) are three in number, uniformly distributed over an outer circumference of the third movable element (7) and over an inner circumference of the second movable element (5), and are made from a series of spiral cut-outs (15) around and towards the axis (X), made in the leaf forming the valve (1). The making of the cut-outs (15) is similar to the making of the cut-outs (11) described earlier.

At rest, the valve (1) is substantially planar as this is illustrated in FIG. 2a. During the opening, the second series of tabs (13) is deformed in a first phase, and the first series of tabs (9) is then deformed, the valve thus has the sectional shape illustrated in FIG. 2b, the third movable element (7), the second movable element (5) and the first fixed element (3) are each located in a plane, the three planes being substantially parallel to each other and substantially perpendicular to the axis (X) of the valve (1).

With reference to FIGS. 3a-3d, we shall describe the operation of the intake valve which has just been described.

As an introductory remark, it should be noted that in the illustrations of FIGS. 3a-3d, the exhaust has been omitted in order to simplify the illustration and to properly describe the intake in a pressurized gas engine equipped with an intake valve according to the invention described above. The pressurized gas engine (20) includes a piston (21) connected through a connecting rod (23) to a camshaft (24). The piston (21) is capable of sliding along an axis, here vertical in the figures, in a cylinder (22) closed on the top by a plate forming a cylinder head (27). The piston (21) includes on an upper face a compression spring (26), here a coil spring. The engine (20) includes above the plate forming the cylinder head (27), a compression chamber (25) capable of containing a hot pressurized gas during operation of the engine (20). The plate forming the cylinder head (27) includes a first communicating passage (28), formed by a series of apertures, between the pressure chamber (25) and the cylinder (22) as well as a second communicating passage (29). The second communicating passage (29) is formed with an aperture with a substantially axisymmetrical cylindrical shape and is located facing the compression spring (26). It is capable of receiving a free end of this compression spring (26) during operation of the pressurized gas engine (20). The valve (1) according to the invention is mounted on a face of the plate forming the cylinder head (27) delimiting the compression chamber (25). In the rest position, as this is illustrated in FIG. 3a, the second movable element (3) closes the first communicating passage (28) while the second movable element (7) closes the second communicating passage (29), the first fixed element (3) being fastened by means known per se onto the plate forming the cylinder head (27) or else crimped in the vertical walls delimiting the compression chamber (25).

During operation of the pressurized gas engine (20), when the piston (21) moves up in the cylinder (22) at the end of the exhaust phase, which will be described later on, the free end of the spring (26) penetrates into the second communicating passage (29) and will press against the third mobile element (7) of the valve (1). As the piston continues its upward movement until it reaches its top dead centre, the compression spring (26) is compressed until its windings become contiguous.

This deformation of the compression spring (26) is made possible because the existing pressure in the compression chamber (25) applies the intake valve (1) against the plate forming the cylinder head (27). The force generated by this pressure on the third movable element (7) (this force has a value equal to the pressure multiplied by the surface area of the third movable element (7)) is greater than the opposite force exerted by the compression spring (26) during its compression. Once the spring is compressed with its windings being contiguous, the force exerted by the latter on the third movable element (7) becomes greater than the force exerted by the pressure prevailing in the compression chamber (25) on this same third movable element (7). So, the compression spring (26) lifts the third movable element (7) by elastically deforming the tabs (13) while the second movable element (5) remains flattened against the plate forming the cylinder head (27) by the pressure prevailing in the compression chamber (25), keeping the first communicating passage (28) closed. This intake phase is illustrated in FIG. 3b. Once the third movable element (7) is lifted, a hot pressurized gas flow (G) is established around the cut-outs (15) of the leaves (13) and then penetrates into the communicating passage (29). Consequently, the pressure prevailing in the compression chamber (25) will press on the piston (21) facing the second communicating passage (29), forcing the latter to initiate a downward movement in the cylinder (22) and establish a variable-volume chamber (30). Consequently, at the first communicating passage (28), on either side of the second movable element (25) the same pressure prevails. On the other hand, the spring (26) continues to return towards its rest position while pushing upwards on the third movable element (7) (the same pressure being exerted on either side of the third movable element) which itself then drives in its movement the second element (5) causing the opening of the first communicating passage (28), so that the hot gas flow (G) from the compression chamber (25) to the variable-volume chamber (30) located between the plate forming the cylinder head (27) and the upper face of the piston (21) may be increased. This situation is illustrated in FIG. 3c. While the piston continues its downward movement, the compression spring (26) is again found in a decompressed rest position. Consequently, the free end of the spring (26) in contact with the third movable element (7) follows the movement of the piston and moves down again into the second communicating passage (28) under the return forces due to the deformed tabs (13) on the one hand, and to the deformed tabs (9) on the other hand. The second (5) and third (7) movable elements of the valve (1) perform the same movement and will successively be flattened on the first communicating passage (28) and the second communicating passage (29), respectively, closing the latter. Consequently, no hot pressurized gas flow (G) exists between the compression chamber (25) and the variable-volume chamber. However, the hot pressurized gas introduced into the variable-volume chamber (30) expands and the piston (21) continues its downward movement until it reaches the bottom dead centre which will trigger the initiation of the exhaust phase as described below. Once the valve (1) has closed the communicating passages (28) and (29), the latter remains flattened in the closed position under the effect of the pressure difference which exists between the pressure prevailing in the compression chamber (25) and the lower pressure prevailing in the variable-volume chamber (30).

From an energy point of view, the sole amount of energy required for setting the intake valve (1) into motion, is the energy required for deforming the compression spring (26) until its windings become contiguous. It should be noted that this energy required for deforming the compression spring (26) until its windings become contiguous, is very small as compared with the energy required for operating camshafts which will press on valves as in document US 2005/0257523.

With reference to FIG. 4, we shall describe an exhaust valve according to the invention as well as the exhaust phase. The exhaust valve (40) in its principle, is similar to the intake valve (1) which has just been described. The exhaust valve (40) is of a general substantially axisymmetrical shape and appears as a leaf with small thickness. Moreover, the thickness of the leaf is less than or equal to about 1 mm, advantageously less than or equal to 3/10^{th} of a mm. The exhaust valve (40) includes a first fixed element (42) with a role similar to that of the first fixed element (3) of the intake valve (1) described earlier. Also, the exhaust valve (40) has a second movable element (41), with a role similar to the second movable element (5) of the intake valve (1). And similarly, a series of tabs (43) connects the first movable element (42) to the second movable element (41). The making of the tabs (43) is similar to that of the tabs (15) and (9) which we have described for the intake valve (1). The notable difference between the intake valve (1) and the exhaust valve (40) is that at rest, the exhaust valve is in the open position as illustrated in FIG. 4, i.e. the second element (41) which forms a substantially planar ring, is located in a different plane and substantially parallel to a plane containing the first fixed element (42) itself shaped as a substantially planar ring. Once they are cut out, the tabs (43) are plastically deformed so that the valve (40) has this configuration at rest. As this is illustrated in FIG. 4, the plate forming the cylinder head (27) includes a series of orifices (44) forming a communicating passage between the variable-volume chamber (30) and the exhaust pipe (50). These apertures (44) are uniformly distributed over a circumference and are located facing the mobile element (41) of the exhaust valve (40). It should be noted that the orifices (28) forming the first communicating intake passage are themselves uniformly distributed over a circumference and facing the second movable element (5) of the intake valve, as this is illustrated in FIG. 5. The piston (21) is equipped with a supporting spring (45), the constitution of which here is similar to that of the exhaust valve (40). Indeed, the supporting spring (45) has a first fixed element (47) capable of allowing the fastening of the supporting spring (45) onto the piston (21), and of a second movable element (46) which, once the supporting spring (45) is mounted on the piston (21), is located facing the second movable element (41) of the intake valve (40). The second movable element (46) of the supporting spring (45) is connected to the first fixed element (47) of the supporting spring (45) through a series of spiral tabs (48) similar to the spiral tabs (43) of the exhaust valve (40).

We shall now describe the operation of the exhaust valve (40) according to the invention. During the intake and expansion phases, the pressure which prevails in the variable-volume chamber (30) is greater than the pressure existing in the exhaust pipe (50) to which the orifices (44) give access. With this pressure, it is possible to maintain in the closed position the second movable element (41) flattened onto the plate forming the cylinder head (27) closing the orifices (44), and this in spite of the return forces exerted by the then elastically deformed tabs (43).

When the piston, during the expansion phase following the intake phase, arrives in its bottom dead centre position as illustrated in FIG. 4, it then causes communication of the variable-volume chamber (30) with an orifice (52) of the wall of the cylinder (22). This orifice (52) is connected to a manifold (51) which leads in its upper portion to the exhaust pipe. The manifold (51) establishes a so-called load-shedding circuit. Consequently, by means of this load-shedding circuit, the pressure prevailing in the variable-volume chamber (30) becomes equal to the pressure prevailing in the exhaust pipe beyond the apertures (44). At this moment, under the effect of the elastic return of the spiral tabs (43), the second movable element (41) of the exhaust valve (40) is detached from the plate forming the cylinder head (27) thereby opening the apertures (44) which will allow the gas contained in the variable-volume chamber (30) to be discharged upon an upward motion of the piston (21) towards the top dead centre. Before the piston (21) reaches its top dead centre, notifying the beginning of the intake cycle which has been described above, the mobile element (46) of the supporting spring (45) will come into contact with the movable element (41) of the exhaust valve (40), with which it will be possible to again flatten the movable element (41) of the exhaust valve (40) onto the plate forming the cylinder head (27) in order to close the orifices (44) and this until the onset of the intake phase described earlier. We recall that on the onset of this intake phase, a pressure equivalent to the pressure established in the compression chamber (25) is established in the variable-volume chamber (30), a pressure which is greatly sufficient for then maintaining via the movable element (41) of the exhaust valve (40), closure of the exhaust orifices (44) until the load-shedding circuit (51) is applied, when again the piston (21) will reach its low dead centre again.

From an energy point of view, the only energy consumption required for operating this exhaust valve (40) according to the invention is the energy required for deforming the spiral tabs (43) of the exhaust valve (40), an expense of energy which remains much less than for operating a camshaft such as for the hot gas engine of the Ericsson type described in document US 2005/0257523.

It should be noted that depending on the engine speed and on the operating temperatures, a filling rate of the variable-volume chamber during an intake phase may fluctuate about an ideal rate avoiding jamming of the operating cycle of the engine. By using an exhaust valve according to the invention, it is possible to “erase” and to get rid of these possible fluctuations:
in the case of under-filling of the variable-volume chamber, the opening of the exhaust valve according to the invention occurs before the bottom dead centre of the piston. This generally avoids at the end of the stroke of the expansion cycle, a depression in the variable-volume chamber opposed to the movement of the piston and therefore consuming energy.
in the case of over-filling of the variable-volume chamber, the load-shedding circuit allows opening of the exhaust valve according to the invention in the bottom dead centre position of the piston which avoids jamming the operation of the cycle.

Thus, the operating stability of the exhaust is therefore ensured and its operation remains optimum regardless of the filling rate of the cylinder.

With reference to FIG. 6, we shall now briefly describe an alternative embodiment both of the exhaust valve according to the invention and of the intake valve still according to the invention.

The intake valve (100) of this alternative embodiment is different from the intake valve (1) described earlier by the presence of a series of orifices (101) uniformly distributed over a circumference of the second movable element of the intake valve (100). Between two successive orifices (101), the second movable element of the intake valve (100) has a material arm (102). The number of orifices (101) is identical with the number of orifices forming the first communicating passage (28) in the plate forming the cylinder head (27). However, each orifice of the plate forming the cylinder head (27) is facing an arm (102) of the second movable element of the intake valve (100). Thus, when the second movable element of the intake valve (100) is flattened against the plate forming the cylinder head (27), each arm (102) closes a corresponding orifice of the first communicating passage (28). The presence of the orifices (101) on the intake valve (100) allows maximum optimization of the hot pressurized gas flow (G) upon opening this intake valve (100), while making the valve per se lighter.

Similarly, the exhaust valve (110) of this alternative embodiment is different from the exhaust valve (40) described earlier by the presence of a series of apertures (111) uniformly distributed over a circumference of the second movable element of the exhaust valve (40). Also, a material arm (112) is located between two consecutive orifices (111). The number of orifices (111) is similar to the number of exhaust orifices (44) made in the plate forming the cylinder head (27). However, each arm (112) is located facing a corresponding orifice (44). Thus, when the second movable element of the exhaust valve (110) is flattened against the plate forming the cylinder head (27), the arm (112) will close the associated orifice (44). Also, with the presence of an orifice (111) it is possible to maximally optimize the exhaust flow of gas present in the variable-volume chamber during the exhaust phase, while making the valve per se lighter.

It should be noted that the use of valves according to the invention in a pressurized gas engine allows conciliation of low energy expense upon their application and optimization of the gas flows. It is thereby possible to reach high speeds of rotation of the engine with a high operating yield. For example, the difference of driving power brought into play in a traditional internal combustion engine and of that in a pressurized gas engine may be of a factor ten. This factor exists between an explosion generating about 30 bars (in an internal combustion engine) and the expansion of compressed gas at 3 bars (in a pressurized gas engine). As the drivability of the expansion of a weakly compressed gas is less, the passive resistances related to friction, to the driving of camshafts and to the force for actuating the valve springs rapidly assume significant proportions which may destroy the overall yield.

As compared with a solution with valves as illustrated in document US 2005/0257523, the distribution mechanism using valves according to the invention sets low masses into motion (the leaf forming the valves according to the invention has a thickness of less than or equal to about 1 mm, advantageously less than or equal to 3/10^{th} of a retained by elastically deformable coupling means having low actuation forces. By reducing the masses in motion, response times may be obtained which are compatible with high actuation frequencies without overdimensioning the elastically deformable coupling means in stiffness. With these considerations, it is possible to reduce by a factor of about ten the actuation energy of the distribution as compared with a traditional solution with massive valves with equivalent openings as illustrated in document US 2005/0257523.

On the other hand, in a pressurized gas engine, the maximum pressure continuously prevails in the feed pipe. Thus the force required for opening a traditional intake valve is proportional to its surface area. The staged opening of the intake valve according to the invention reduces the required actuation energy while providing a significant pressurized gas flow from the compression chamber to the variable-volume chamber. This contributes to feeding the engine in an optimum way by improving the filling rate at a high speed of rotation. The actuation energy of an equivalent monolithic non-staged valve would be ten to thirty times greater. Thus, with this, the section for letting through the gas may be increased independently of the force to be provided for opening the valve according to the invention. This is impossible with a traditional valve.

By using valves according to the invention in a pressurized gas engine, high expansion yields may be obtained by minimizing the actuation energies of the distribution while being compatible with significant gas flows facilitating the revving-up of the engine without destroying the filling rate of the variable-volume chamber.

It should be noted that the valves according to the invention naturally operate in the direction of the gas flow: it is the pressure difference between both faces of the valve which conditions its opening or its closing. Here, within the scope of hot gas engines, the valves according to the invention then operate against the gas flow and therefore against the pressure difference between both faces of the valve.

Of course, it is possible to make many modifications to the invention without however departing from the scope thereof.

1. A system intended for a pressurized gas engine (20), including:
a variable-volume chamber (30); and
a valve (1, 40; 100, 110) comprising a first fixed element (3, 42) intended to allow fastening of the valve onto the engine, a second movable element (5, 41) intended to shut off in a conditional manner, a passage (28, 44) providing gas communication with the variable-volume chamber, first elastically deformable coupling means (9, 43) connecting the first and second elements together,
characterized in that the chamber includes means (26; 45) for operating the second movable element of the valve.

2. The system according to claim 1, characterized in that the valve is a one-piece valve.

3. The system according to any of claim 1 or 2, characterized in that the valve forms a substantially planar leaf before deformation.

4. The system according to any of claims 1 to 3, characterized in that the valve has substantially a circular shape.

5. The system according to claim 4, characterized in that the first and second elements have a concentric ring shape.

6. The system according to claim 5, characterized in that, at rest, the first and second elements are substantially in a same plane.

7. The system according to claim 5, characterized in that, at rest, the first and second elements are in two different planes substantially parallel with each other.

8. The system according to any of claims 1 to 7, characterized in that the valve includes a third movable element (7) intended to shut off a second passage (29) providing gas communication with the variable-volume chamber (30) and second deformable coupling means (13) connecting the second and third elements together.

9. The system according to claim 8, characterized in that the third element has substantially the shape of a disk.

10. The system according to any of claims 1 to 9, characterized in that the first and/or second elastically deformable coupling means include tabs (9, 13, 43).

11. The system according to claim 10, characterized in that the tabs have substantially spiral shapes and are uniformly distributed over a circumference of the valve.

12. The system according to any of claims 8 to 11, characterized in that the operating means are intended for operating the third movable element of the valve.

13. The system according to any of claims 1 to 12, characterized in that the operating means include an elastically deformable element mounted on a piston delimiting the variable-volume chamber.

14. The system according to claim 13, characterized in that the elastic deformable element is of the compression spring type.

15. A pressurized gas engine of the type (20) characterized in that it includes at least one valve according to any of claims 1 to 14.
